(19) United States
(12) Patent Application Publication
(10) Pub. No.: US 2006/0212654 A1
(43) Pub. Date: Sep. 21, 2006

(54) Method and apparatus for intelligent instruction caching using application characteristics

(76) Inventor: Vinod Balakrishnan, Menlo Park, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/083,795

(22) Filed: Mar. 18, 2005

(51) Int. Cl. G06F 12/00

(52) U.S. Cl. 711/125; 711/134

(57) ABSTRACT

A method and apparatus for intelligent instruction caching using application characteristics. In conjunction with building an application or application module, a function address map is generated identifying the location of functions to be cached in the application or module code. In conjunction with loading the application/module into system memory, a function memory map is generated in view of the function address map and the location at which the application/module was loaded, so as to define the location in system memory of the functions to be cached. In response to a cache miss for an instruction, the function memory map is searched to determine if the instruction corresponds to the first instruction of a function to be cached. If it does, the instructions corresponding to the function are loaded into the cache. In one embodiment, a first portion of the instructions are immediately loaded into the cache, while a second portion of the instructions are asynchronously loaded using a background task.

### FIELD OF THE INVENTION

The field of invention relates generally to computer systems and, more specifically but not exclusively relates to techniques for intelligent instruction caching using application characteristics.

### BACKGROUND INFORMATION

General-purpose processors typically incorporate a coherent cache as part of the memory hierarchy for the systems in which they are installed. The cache is a small, fast memory that is close to the processor core and may be organized in several levels. For example, modern microprocessors typically employ both first-level (L1) and second-level (L2) caches on die, with the L1 cache being smaller and faster (and closer to the core), and the L2 cache being larger and slower. Caching benefits application performance on processors by using the properties of spatial locality (memory locations at adjacent addresses to accessed locations are likely to be accessed as well) and temporal locality (a memory location that has been accessed is likely to be accessed again) to keep needed data and instructions close to the processor core, thus reducing memory access latencies.

In general, there are three types of overall cache schemes (with various techniques for implementing each scheme). These include the direct-mapped cache, the fully-associative cache, and the n-way set-associative cache. Under a direct-mapped cache, each memory location is mapped to a single cache line that it shares with many others; only one of the many addresses that share this line can use it at a given time. This is the simplest technique both in concept and in implementation. Under this cache scheme, the circuitry to check for cache hits is fast and easy to design, but the hit ratio is relatively poor compared to the other designs because of its inflexibility.

Under fully-associative caches, any memory location can be cached in any cache line. This is the most complex technique and requires sophisticated search algorithms when checking for a hit. It can lead to the whole cache being slowed down because of this, but it offers the best theoretical hit ratio, since there are so many options for caching any memory address.

n-way set-associative caches combine aspects of direct-mapped and fully-associative caches. Under this approach, the cache is broken into sets of n lines each (e.g., n=2, 4, 8, etc.), and any memory address can be cached in any of those n lines. Effectively, the sets of cache line are logically partitioned into n groups. This improves hit ratios over the direct mapped cache, but without incurring a severe search penalty (since n is kept small).

Overall, caches are designed to speed-up memory access operations over time. For general-purpose processors, this dictates that the cache scheme work fairly well for various types of applications, but may not work exceptionally well for any single application. There are several considerations that affect the performance of a cache scheme. Some aspects, such as size and access latency, are limited by cost and process limitations. Access latency is generally determined by the fabrication technology and the clock rate of the processor core and/or cache (when different clock rates are used for each).

Another important consideration is cache eviction. In order to add new data and/or instructions to a cache, one or more cache lines are allocated. If the cache is full (normally the case after start-up operations), the same number of existing cache lines must be evicted. Typically eviction policies include random, least recently used (LRU) and pseudo LRU. Under current practices, the allocation and eviction policies are performed by corresponding algorithms that are implemented by the cache controller hardware. This leads to inflexible eviction policies that may be well-suited for some types of applications, while providing poor-performance for other types of applications.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein like reference numerals refer to like parts throughout the various views unless otherwise specified:

FIG. 1 is a schematic diagram illustrating a typical memory hierarchy employed in modern computer systems;

FIG. 2 is a flowchart illustrating operations performed during a conventional caching process;

FIG. 3 is a schematic diagram illustrating an overview of a function-based caching scheme, according to one embodiment of the invention;

FIG. 3a is a schematic diagram illustrating an alternative cache loading scheme under which a first cache line for a function is loaded immediately, while the remaining instructions are loaded asynchronously using a background task;

FIG. 3b is a schematic diagram illustrating a function-based caching scheme implemented using an L2 cache and an L1 instruction cache, according to one embodiment of the invention;

FIG. 4 is a flowchart illustrating operations and logic employed to perform the function-based caching scheme of FIG. 3;

FIG. 5 is a flowchart illustrating operations performed during the build-time phase of FIG. 3 to prepare an application to support function-based caching;

FIG. 6 is a flowchart illustrating operations performed during the application load phase of FIG. 3;

FIG. 7 is a flowchart illustrating operations and logic employed to perform the multiple cache level function-based caching scheme of FIG. 3b;

FIG. 8a is a pseudocode listing illustrating exemplary pragma statements used to delineate portions of code that are marked for function-based caching, according to one embodiment of the invention;

FIG. 8b is a pseudocode listing illustrating exemplary pragma statements used to delineate portions of code that are assigned to different cache levels under function-based caching levels, according to one embodiment of the invention;

FIG. 9 is a schematic diagram of a 4-way set associative cache architecture under which one of the groups of cache lines is assigned to a function-based cache pool, while the remaining groups of cache lines are assigned to a normal usage cache pool; and

FIG. 10 is a schematic diagram illustrating an exemplary computer system and processor on which cache architecture embodiments and function-based caching schemes described herein may be implemented.

### DETAILED DESCRIPTION

Embodiments of methods and apparatus for intelligent instruction caching using application characteristics are described herein. In the following description, numerous specific details are set forth to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

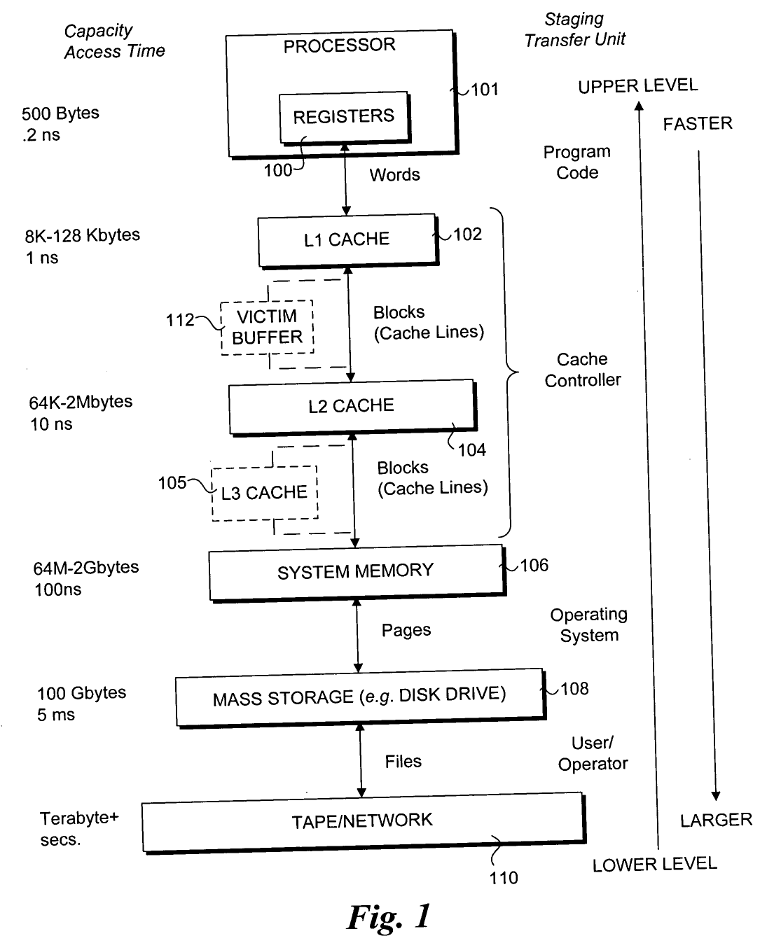

A typical memory hierarchy model is shown in FIG. 1. At the top of the hierarchy are processor registers 100 in a processor 101, which are used to store temporal data used by the processing core, such as operands, instruction op codes, processing results, etc. At the next level are the hardware caches, which generally include at least an L1 cache 102, and typically further may include an L2 cache 104. Some processors also provide an integrated level 3 (L3) cache 105. These caches are coupled to system memory 106 (via a cache controller), which typically comprises some form of DRAM-(dynamic random access memory) based memory. In turn, the system memory is used to store data that is generally retrieved from one or more local mass storage devices 108, such as disk drives, and/or data stored on a backup store (e.g., tape drive) or over a network, as depicted by tape/network 110.

Many newer processors further employ a victim cache (or victim buffer) 112, which is used to store data that was recently evicted from the L1 cache. Under this architecture, evicted data (the victim) is first moved to the victim buffer, and then to the L2 cache. Victim caches are employed in exclusive cache architectures, wherein only one copy of a particular cache line is maintained by the various processor cache levels.

As depicted by the exemplary capacity and access time information for each level of the hierarchy, the memory near the top of the hierarchy has faster access and smaller size, while the memory toward the bottom of the hierarchy has much larger size and slower access. In addition, the cost per storage unit (Byte) of the memory type is approximately inverse to the access time, with register storage being the most expensive, and tape/network storage being the least expensive. In view of these attributes and related performance criteria, computer systems are typically designed to balance cost vs. performance. For example, a typically desktop computer might employ a processor with a 16 Kbyte L1 cache, a 256 Kbyte L2 cache, and have 512 Mbytes of system memory. In contrast, a higher performance server might use a processor with much larger caches, such as provided by an Intel® Xeon™ MP processor, which may include a 20 Kbyte (data and execution trace) cache, a 512 Kbyte L2 cache, and a 4 Mbyte L3 cache, with several Gbytes of system memory.

One motivation for using a memory hierarchy such as depicted in FIG. 1 is to segregate different memory types based on cost/performance considerations. At an abstract level, each given level effectively functions as a cache for the level below it. Thus, in effect, system memory 106 is a type of cache for mass storage 108, and mass storage may even function as a type of cache for tape/network 110.

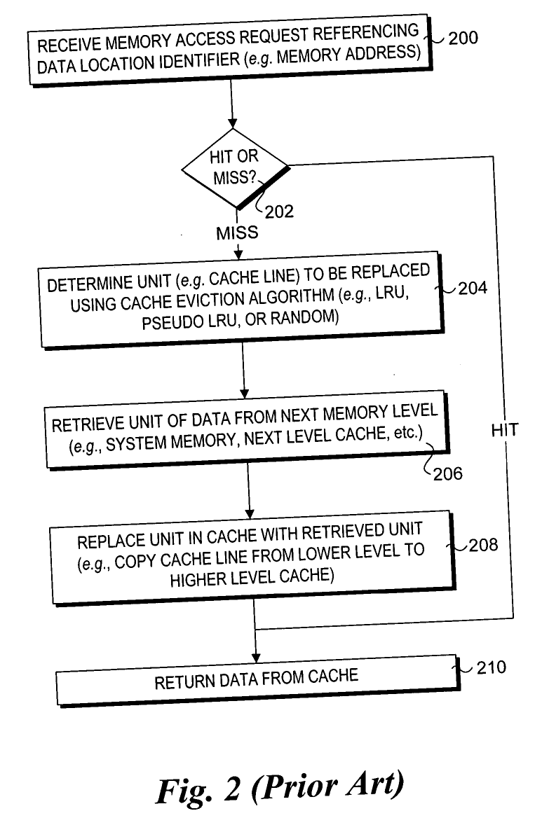

With these considerations in mind, a generalized conventional cache usage model is shown in FIG. 2. The cache usage is initiated in a block 200, wherein a memory access request is received at a given level referencing a data location identifier, which specifies where the data is located in the next level of the hierarchy. For example, a typical memory access from a processor will specify the address of the requested data, which is obtained via execution of corresponding program instructions. Other types of memory access requests may be made at lower levels. For example, an operating system may employ a portion of a disk drive to function as virtual memory, thus increasing the functional size of the system memory. In doing so, the operating system will “swap” memory pages between the system memory and disk drive, wherein the pages are stored in a temporary swap file.

In response to the access request, a determination is made in a decision block 202 to whether the requested data is in the applicable cache—that is the (effective) cache at the next level in the hierarchy. In common parlance, the existence of the requested data is a “cache hit”, while the absence of the data results in a “cache miss”. For a processor request, this determination would identify whether the requested data was present in L1 cache 102. For an L2 cache request (issued via a corresponding cache controller), decision block 202 would determine whether the data was available in the L2 cache.

If the data is available in the applicable cache, the answer to decision block 202 is a HIT, advancing the logic to a block 210 in which data is returned from that cache to the requester at the level immediately above the cache. For example, if the request is made to L1 cache 102 from the processor and the data is present in the L1 cache, it is returned to the processor (the requester). However, if the data is not present in the L1 cache, the cache controller issues a second data access request, this time from the L1 cache to the L2 cache. If the data is present in the L2 cache, it is returned to the L1 cache, the current requester. As will be recognized by those skilled in the art, under an inclusive cache design, this data would then be written to the L1 cache and returned from the L1 cache to the processor. In addition to the configurations shown herein, some architectures employ a parallel path, whether the L2 cache returns data to the L1 cache and the processor simultaneously.

Now let's suppose the requested data is not present in the applicable cache, resulting in a MISS. In this case, the logic proceeds to a block 204, wherein the unit of data to be replaced (by the requested data) is determined using an applicable cache eviction policy. For example, in an L1, L2, and L3 caches, the unit of storage is a “cache line” (the nit of storage for a processor cache is also referred to as a block, while the replacement unit for system memory typically is a memory page). The unit that is to be replaced comprises the evicted unit, since it is evicted from the cache. The most common algorithms used for conventional cache eviction are LRU, pseudo LRU, and random.

In conjunction with the operations of block 204, the requested unit of data is retrieved from the next memory level in a block 206, and used to replace the evicted unit in a block 208. For example, suppose the initial request was made by a processor, and the requested data is available in the L2 cache, but not the L1 cache. In response to the L1 cache miss, a cache line to be evicted from the L1 cache will be determined by the cache controller in a block 204. In parallel, a cache line containing the requested data in L2 will be copied into the L1 cache at the location of the cache line selected for eviction, thus replacing the evicted cache line. After the cache data unit is replaced, the applicable data contained within the unit is returned to the requester in block 210.

Under the conventional scheme, cache load and eviction policies are static. That is, they are typically implemented via programmed logic in the cache controller hardware, which cannot be changed. For instance, a particular processor model will have a specific cache load and eviction policy embedded into its cache controller logic, requiring that load and eviction policy to be employed for all applications that are run on systems employing the processor.

This conventional scheme is often inefficient. For example, a typical cache line is 32-bytes long, the size of only a few instructions. Conversely, application programs and the like are generally structured as a collection of functions and separate code sections, with each function having a variable length that is much longer than the length of a cache line. Thus, execution of a given function typically involves loading multiple cache lines in a cyclical manner, leading to significant memory access latencies.

In accordance with embodiments of the invention, mechanisms are provided for controlling cache load and eviction policies based on application characteristics. This enables a set of instructions for a given function to be cached all at once (either as an immediate foreground task or asynchronous background task), significantly reducing the number of cache misses and their associated memory access latencies. As a result, applications run faster, and processor utilization is increased.

As an overview, a basic embodiment of the invention will first be discussed to illustrate general aspects of the function-based cache policy control mechanism. Additionally, an implementation of this embodiment using a high-level cache (e.g., L1, or L2) will be described to illustrate general principles employed by the mechanism. It will be understood that these general principles may be implemented at other cache levels in a similar manner, such as at the system memory level.

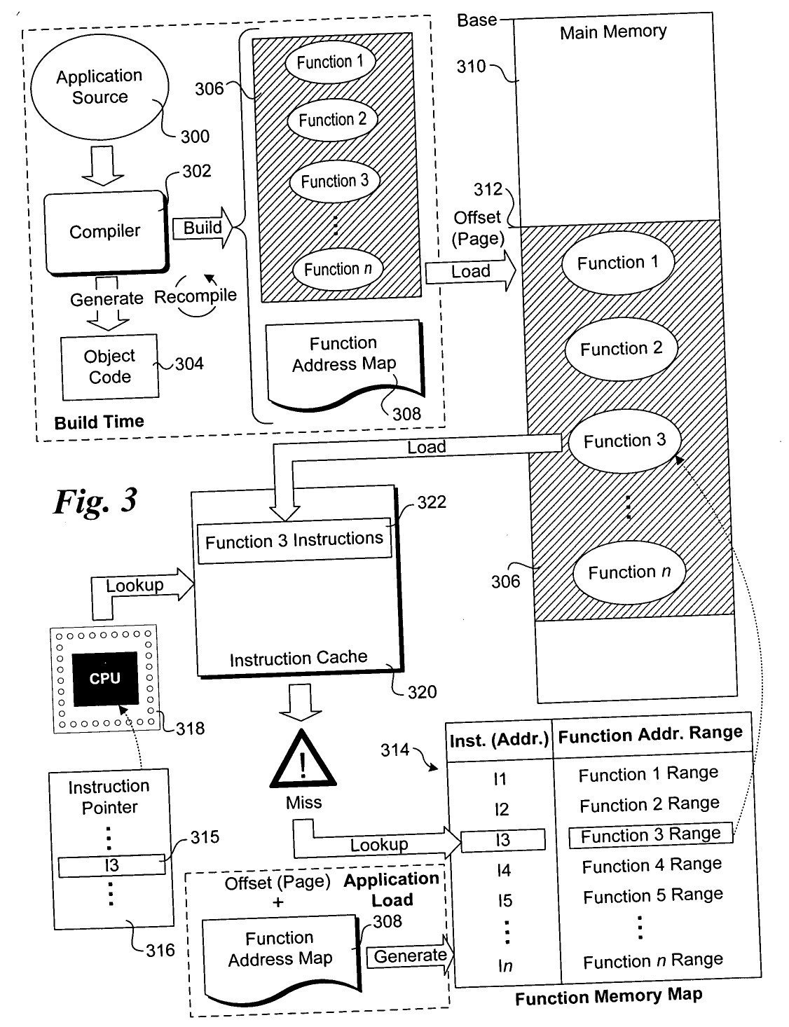

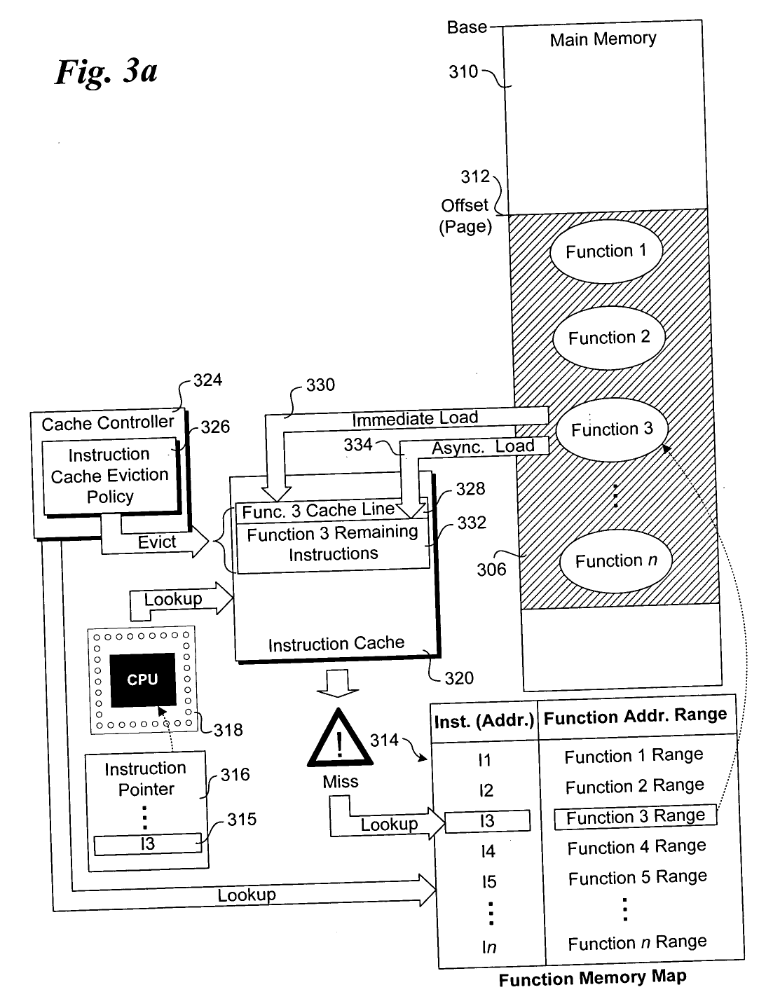

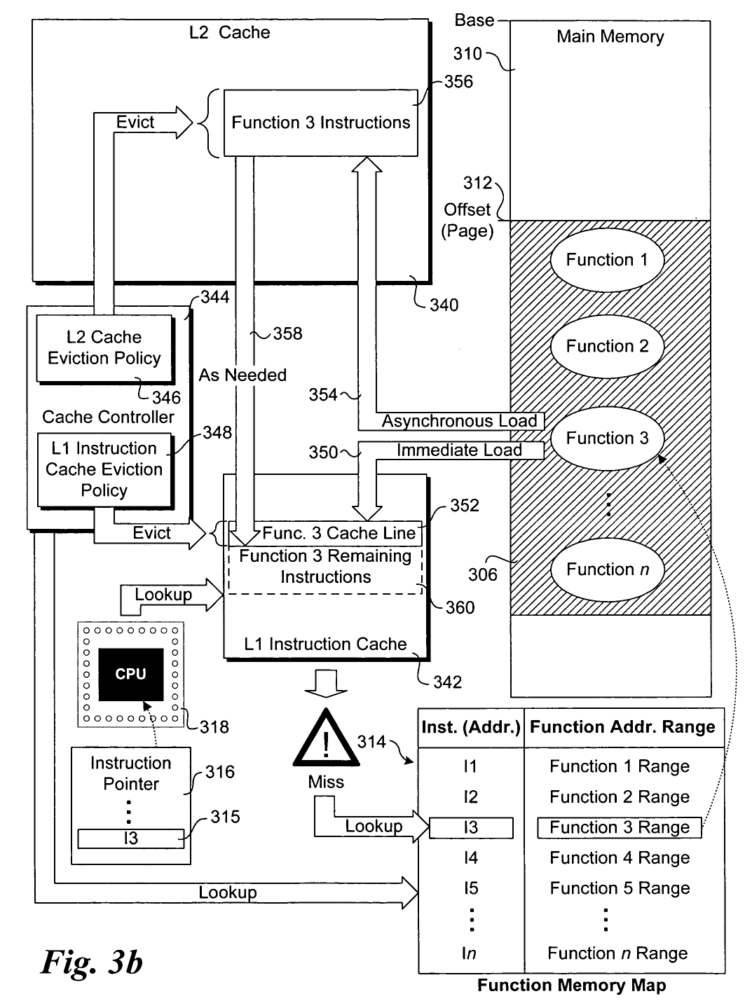

FIG. 3 depicts a schematic diagram illustrating various aspects of one embodiment of the invention. These aspects cover three operational phases: build time (depicted in the dashed block labeled “Build Time”), application load (depicted in the dashed block labeled “Application Load”), and application run time (the rest of the operations not included in either the Build Time or Application Load blocks).

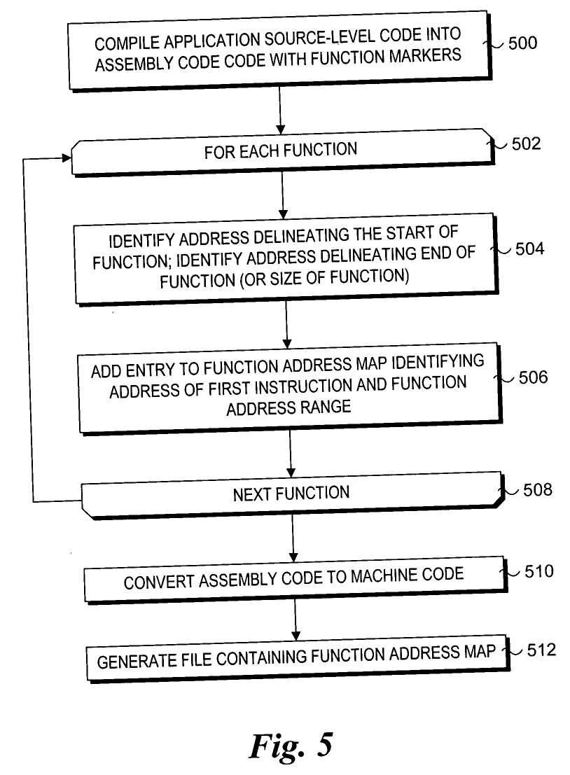

During the build time phase, application source code 300 is written using a corresponding programming language and/or development suite, such as but not limited to C, C++, C#, Visual Basic, Java, etc. As used throughout the figures herein, the exemplary application includes multiple functions 1-n, each used to perform a respective task or sub-task. As is conventionally done, application source code 300 is compiled by a compiler 302 to build object code 304. Object code 304 is then recompiled and/or linked to library functions to build machine code (e.g., executable code) 306. In conjunction with this second compilation/linking operation, compiler 302 (or a separate tool) builds a function address map 308. The function address map includes a respective entry for each function identifying the location (i.e., address) of that function within machine code 306, further details of which are described below with reference to FIG. 5.

During the application load phase, machine code 306 is loaded into main memory 310 (also commonly referred to as system memory) for a computer system in the conventional manner. For simplicity, the machine code for the exemplary application is depicted as comprising a single module that is loaded as a contiguous block of instructions, with the start of the block beginning at an offset address 312. It will be understood that the principles described herein may be applied to applications comprising multiple modules that may be loaded into main memory 310 in a contiguous or discontiguous manner.

In general, the computer system may employ a flat (i.e. linear) addressing scheme, a virtual addressing scheme, or a page-based addressing scheme (using real or virtual addresses), each of which are well-known in the computer arts. For illustrative purposes, page-based addressing is depicted in the figures herein. Under a page-based addressing scheme, the instructions for a given application module are loaded into one or more pages of main memory 310, wherein the base memory address of the first page defines offset 312.

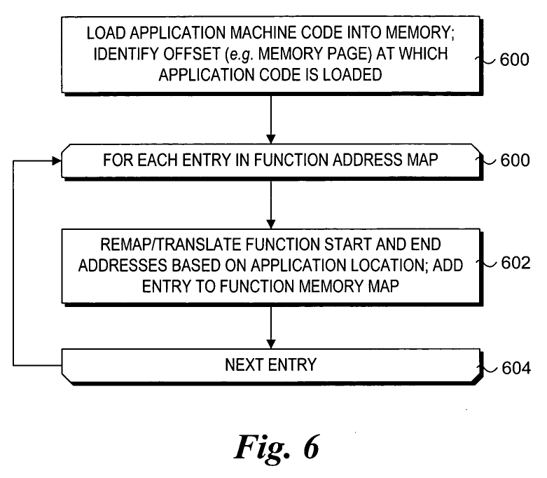

In conjunction with loading the application machine code, entries for a function memory map 314 are generated. In one embodiment, this involves adding offset address 312 to the starting address of each function in machine code 306, as explained below in further detail with reference to FIG. 6. Other schemes may also be employed. The net result is a respective entry for each function is entered into function memory map 314 that maps the location in main memory 310 for that function.

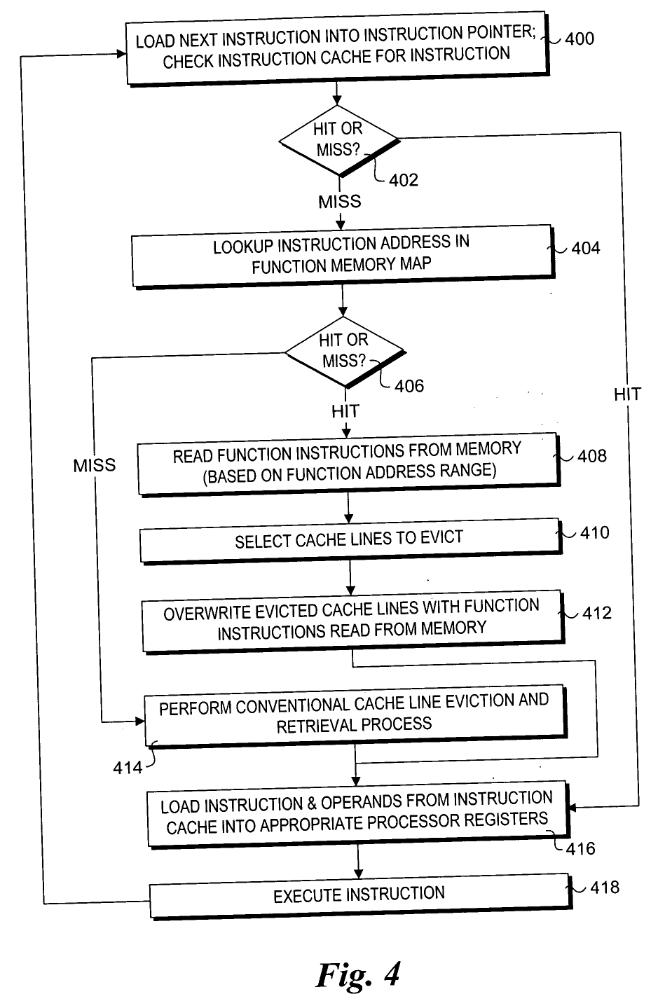

The remaining operations illustrated in FIG. 3 pertain to run-time phase operations performed on an ongoing basis after the application load phase. Details of operations and logic pertaining to one embodiment of the run-time phase are shown in FIG. 4. The ongoing process begins at a block 400, in which the address for a next instruction 315 is loaded into the instruction pointer 316 of a processor 318, followed by a check (lookup) of an instruction cache 320 to determine if the instruction is present in the cache (based on a corresponding entry in instruction cache 320 referencing the instruction address). If the instruction is present in instruction cache 320, the result of a decision block 402 is a cache HIT, causing the logic to proceed to a block 416, which loads the instruction from the instruction cache, along with any applicable operands, into appropriate instruction registers for processor 318. The instruction is then executed in a block 418, and the logic is returned to block 400 to load the instruction pointer with the next instruction address. These operations are similar to those performed for a cache HIT under a conventional caching scheme.

Returning to decision block 402, suppose that the instruction is not present in instruction cache 320. This results in a cache MISS, causing the logic to proceed to a block 404 in which a lookup of the instruction address in function memory map 314 is performed. As discussed above, function memory map 314 contains an entry for each function that maps the location of that function in main memory 310. In the illustrated embodiment of FIG. 3, each entry includes the address for the first instruction for each function, and this address is used as a search index. Thus, if the instruction pointed to by the instruction pointer is the first instruction for a function, function memory map 404 will include a corresponding entry, and the answer to decision block 406 will be a HIT. However, if the instruction does not corresponding to the first instruction of a function (which will be most of the time), the result of decision block 406 will be a MISS. In response to a MISS, the logic proceeds to a block 414, wherein a conventional cache line eviction and retrieval process is performed in a manner similar to that discussed above with reference to FIG. 2. This results in the instruction being retrieved from main memory 310 into instruction cache 320, whereupon the instruction and applicable operands are loaded into appropriate processor registers in block 416 and the instruction is executed in block 418.

If an entry corresponding to the instruction (e.g., suppose the next instruction that is loaded is instruction I3, the first instruction for Function 3) is present in function memory map 314, decision block 406 produces a HIT, causing the logic to proceed to a block 408. In this block, the instructions for the corresponding function (e.g., Function 3) are read from memory, based on the function address range or other data present in function memory map 314. Concurrently, an appropriate set of cache lines to evict from instruction cache 320 is selected in a block 410. The number of cache lines to evict will depend on the nominal size of a cache line and the size of the function instructions that are read in block 408. The cache lines selected for eviction are then overwritten with the instructions read from main memory 310 (block 408) in a block 412, as depicted by Function 3 instructions 322, thus loading the function instructions into instruction cache 320. The logic then proceeds to block 416 to load the first instruction of the function (i.e., the current instruction pointed to by instruction pointer 316) and any applicable operands into appropriate registers in processor 318 and executed in a block 418.

Details of an alternate embodiment under which the instructions for a function are loaded into the instruction cache using an immediate load of a first cache line and an asynchronous load of the remaining function instructions are shown in FIG. 3a. In addition to similar components having like numbers depicted in FIGS. 3 and 3a, FIG. 3a further depicts a cache controller 324 including an instruction cache eviction policy 326. (It is noted that a similar cache controller and instruction cache eviction policy component would be employed in the embodiment of FIG. 3 but is not shown for lack of space in the drawing figure.)

The operation of FIG. 3a is similar to that shown in FIG. 3 and discussed above with reference to the flowchart of FIG. 4 up to the point that the instructions for Function 3 are loaded into instruction cache 320. However, in this embodiment, the instructions are not loaded all at once. Rather, a first cache line is selected for eviction and loaded with a cache line containing a first portion of instructions 328 for Function 3, as depicted by immediate load arrow 330. This allows for the instructions corresponding to first portion of the function (Function 3 in this instance) to be immediately available for execution by the system processor, as would be the case if a conventional caching scheme was employed.

Meanwhile, the remaining portion of instructions 332 are loaded into instruction cache 320 using an asynchronous background task, as depicted by asynchronous load arrow 334. This involves a coordinated effort by cache controller 324 and instruction cache eviction policy 326, which are employed as embedded functions that are enabled to support both synchronous operations (in response to processor instruction load needs) and asynchronous operations that are independent of the system processor. Thus, as a background task, instruction cache eviction policy 326 selects cache lines to evict based on the number of cache lines needed to load a next “block” of function instructions, which are read from main memory 310 and loaded into instruction cache 320. It is noted that under one embodiment the asynchronous load operations may be ongoing over a short duration, such that instruction cache 320 is incrementally filled with the instructions for a given function using a background task.

FIG. 5 shows operations performed during one embodiment of the build time phase discussed above with reference to FIG. 3. During the build time phase, the machine code for the application is built, along with the function address map. This process begins in a block 500, wherein the application source-level code is compiled into assembly code with function markers. Assembly code is a readable version of machine code that employs mnemonics for each instruction, such as MOV, ADD, SUB, JMP, SHIFT, etc. Assembly code also includes the address for each instruction, such that an address map generated from assembly code will match the address for the machine code that is generated from the assembly code.

The function markers are employed to delineate the start and end points of functions. At the source level, functions are easily identified, based on the source-level language that is employed. Some languages even use the explicit term “function.” However, at the assembly code level, it is difficult to ascertain where a given function starts and ends. Thus, in one embodiment, the assembly compiler inserts markers to delineate the function start and end points at the assembly level.

As depicted by start and end loop blocks 502 and 508, the operations of blocks 504 and 506 are performed for each function marked in the assembly code. In block 504, the address delineating the start of the function is identified, along with either the address delineating the end of the function or the length of the function (from which the end of the function can be determined). In a block 506, a corresponding entry is added to the function address map identifying the address of the first instruction and the function address range. In one embodiment, the function address range data merely comprises the address of the last instruction for the function.

Following the operations of the function address map entry generation loop, the assembly code is converted into machine code in a block 510. In a block 512, a file containing the function address map is generated. In one embodiment, the file comprises a text-based file with a predefined format. In another embodiment, the file comprises a binary file with a predefined format.

FIG. 6 shows operations performed in one embodiment of the application load phase depicted in FIG. 3 and discussed above. This process begins in a block 600, wherein the application machine code is loaded into system memory (e.g., main memory 310), and the offset at which the application machine code is loaded is identified. The location in memory at which an application is loaded will typically be under the control of an operating system on which the application is run. For simplicity, the application will be considered to be loaded at some offset from the base address of the system memory in one contiguous block; it will be understood that the principles described herein may be applied to modular applications loaded at discontiguous locations in a similar manner. As discussed above, the system may generally employ a flat (i.e., linear) addressing scheme, a virtual addressing scheme, or a page-based addressing scheme. In general, a page-based addressing scheme is the most common scheme that is employed in modern personal computers. Under this scheme, address translations between explicit addresses identified in the machine code and the corresponding physical or virtual address at which those instructions actually reside once loaded into system memory is easily handled by simply using the base address of the page at which the start of the application is loaded as the offset.

Once the offset for the application machine code is identified, a remap or translation of the function address map is performed to generate the function memory map. As depicted by start and end loop blocks 600 and the operations depicted in a block 602, each function address map entry is remapped or translated based on the application location, such that the location of the first instruction of each function and the function range in system memory is determined. A corresponding entry is then added to the function memory map.

In general, a function memory map may be implemented as a dedicated hardware component or using a general-purpose memory store. For example, in one embodiment a content-addressable memory (CAM) component is employed. CAMs provide rapid memory lookup based on the address of the memory object being searched for using a hardware-based search mechanism that operates in parallel. This enables the determination of whether a particular memory address (and thus instruction address) is present in the CAM using only a few clock cycles. In one embodiment, each CAM entry contains two components: the address in system memory of the first instruction for a function and the address in system memory of the last instruction of the function.

A low-latency memory store may also be used. In this instance, the function memory map values are configured in a table including a first column containing the system memory addresses of the first instruction. In one embodiment, the first column entries are indexed (e.g., numerically ordered), thus supporting a fast search mechanism. In general, if a low-latency memory store is used, the memory should be close in proximity to the processor core (e.g., on die or on-chip), and should provide very low latency, such as SRAM-static random access memory) based memory.

Both of the foregoing implementations involve the use of a memory resource that is not part of the system memory. Thus, a conventional operating system does not have access to these memory resources. Accordingly, a mechanism is needed to cause the unction memory map to be built in system memory, and then copied into the CAM or low-latency memory store. In one embodiment, the mechanism includes firmware and/or processor microcode that can be accessed by the operating system. In one embodiment, the operating system reads the function address map file to identify the first instruction address and address range of each cacheable function. It then performs the remap/translation operation of block 602 and stores an instance of the function memory map in system memory. It then provides a function memory map load request to either the system firmware or processor that informs the firmware/processor of the location of the function memory map instance and the size of the map. A copy of the function memory map is then loaded into the CAM or low-latency memory store, as applicable.

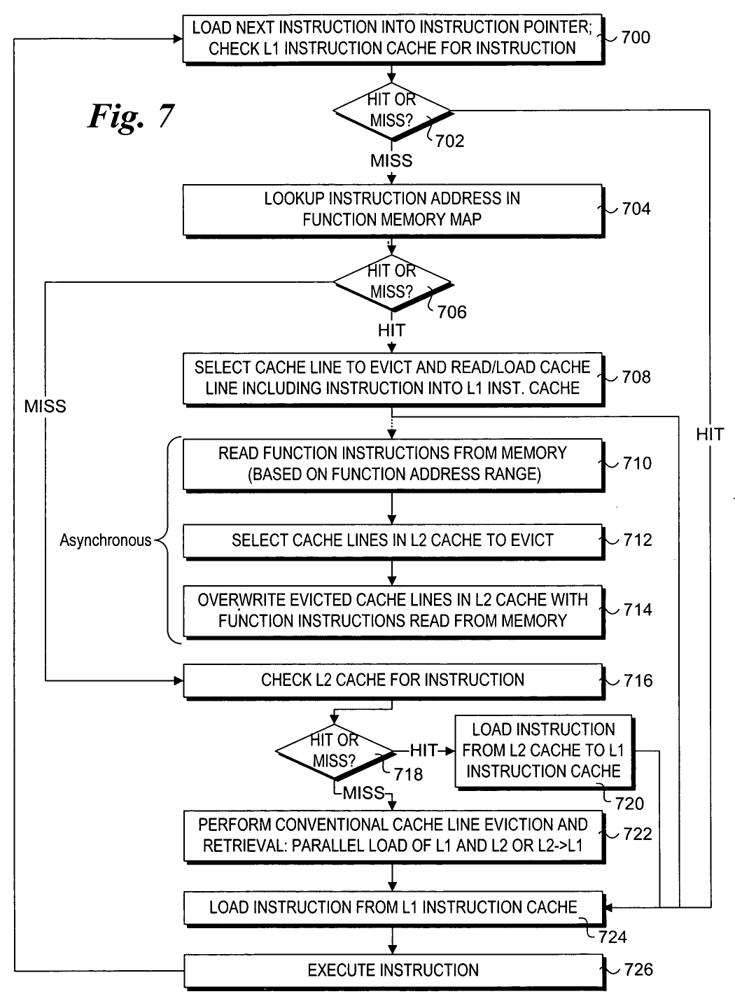

As discussed above, modern computer systems employ multi-level caches, such as an L1 and L2 cache. Accordingly, a scheme is provided for caching function instructions under a multi-level cache scheme. One embodiment of this scheme is schematically depicted in FIG. 3a, while operations and logic for implementing the scheme are shown in FIG. 7.

As shown in FIG. 3b, the system architecture now includes an L2 cache 340 in addition to an L1 instruction cache 342, both of which are managed by a cache controller 344. The cache controller employs an L2 cache eviction policy 346 that is used to control eviction of cache lines in L2 cache 340 and an L1 instruction cache eviction policy 348 that is used to control eviction of cache lines in L1 instruction cache 342.

Referring to FIG. 7, an ongoing process begins in a block 700, wherein the address of a next instruction 315 is loaded into instruction pointer 316, and L1 instruction cache 324 is checked to determine if the instruction (address) is present. If a HIT results, as depicted by a decision block 702, the logic proceeds to a block 724 wherein the instruction is loaded from the L1 instruction cache (along with any applicable operands) and the instruction is executed by processor 318 in a block 726.

If the instruction is not present in L1 instruction cache 342, the result of decision block 702 is a MISS, causing the logic to proceed to a block 704, wherein a lookup of the instruction address in function memory map 314 is performed. If the instruction corresponds to the first instruction of one of the application functions, a corresponding entry will be present in function memory map 314. For the majority of instructions, an entry in function memory map will not exist, resulting in a MISS. As depicted by a decision block 706, a MISS causes the logic to proceed to a block 716, in which L2 cache 340 is checked for the presence of the instruction (via its address). If the instruction is present, the result of a decision block 718 is a HIT, and the instruction is loaded from L2 cache 340 into L1 instruction cache 342 in a block 720. The logic then proceeds to load the instruction from the L1 instruction cache into processor 318 and executed this instruction in accordance with the operations of blocks 724 and 726.

If the result of decision block 718 is a MISS, the logic proceeds to perform a conventional cache line eviction and retrieval process in a block 722. Under this process, a cache line is selected for eviction by L2 cache eviction policy 346, and instructions corresponding to a cache line including the current instruction are read from main memory 310 and the evicted cache line is overwritten with the read instructions. Depending on the implementation, a serial cache load or parallel cache load may be employed for loading L2 cache 340 and L1 instruction cache 342. Under a serial load, after the new cache line is written to L2 cache 340, a copy of the cache line is written to L1 instruction cache 342. This involves a selection of a current cache line to evict in L1 instruction cache 342 by L1 instruction cache eviction policy 348, followed by copying the new cache line from L2 cache 340 to L1 instruction cache 342. Under a parallel load, new cache lines containing the same instructions are loaded into L2 cache 340 and L1 instruction cache 342 in a concurrent manner.

Up to this point, the operations described correspond to conventional operation of a multi-level cache scheme employing an L2 cache and an L1 instruction cache. However, the scheme in FIGS. 3b and 7 departs from the current scheme when current instruction 315 corresponds to the first instruction of an application function. For illustrative purpose, we will assume that current instruction 315 comprises the first instruction 13 of Function 3, as before.

As before, the lookup of L1 instruction cache 342 will result in a MISS, causing the logic to proceed to block 704. This time, an entry corresponding to (the address of) instruction L3 is present in function memory map 314, resulting in a HIT for decision block 706. In response, a new cache line containing the first portion of instructions for Function 3 is immediately loaded into L1 instruction cache 342, as depicted by an immediate load arrow 350. The corresponding operations are depicted in a block 708 in FIG. 7, wherein the L1 instruction cache eviction policy 326 selects a cache line in L1 instruction cache 342 to evict, and the instruction for the new cache line are read from main memory 310 and cache line selected for eviction is overwritten to load a cache line 352 including the first instruction of Function 3.

In conjunction with the operation of block 708, the instructions for Function 3 are loaded into L2 cache 340 using a background task, as depicted by an asynchronous load arrow 354 in FIG. 3b and blocks 710, 712, and 714. These operations are substantially analogous to the asynchronous load operations depicted in FIG. 3a and discussed above, except in this instance the entire Function 3 instructions, including the first cache line, are loaded into L2 cache 340. In block 710, the function instructions are read from main memory 310, with the range of the instructions defined by a corresponding entry in function memory map 314 for the function. In block 712, L2 cache eviction policy 344 selects an appropriate number of cache lines to evict from L2 cache 340. The evicted cache lines are then overwritten in block 714 with the Function 3 instructions that were read from main memory 310 in block 710. This results in cache lines comprising Function 3 instructions 356 being loaded into L2 cache 340. As before, the corresponding cache lines may be loaded using a “bulk” loading scheme, or an incremental loading scheme. In one embodiment, the particular loading scheme that is used will be programmed into cache controller 344.

During subsequent processing of the ongoing loop of FIG. 7, request for retrieval of instructions corresponding to Function 3 will be encountered. Accordingly, in response to a MISSes in decision blocks 702 and 706, cache lines may be loaded from L2 cache 340 on an “as needed” basis, as depicted by as needed arrow 358 and Function 3 remaining instructions 360 in FIG. 3b.

The foregoing operations result in a first cache line of instructions being loaded into an L1 instruction cache, while a copy of the entire function is loaded into an L2 cache. This provides several benefits, particularly for larger functions. Since the size of an L1 instruction cache is generally much smaller than the size of an L2 cache, it may be inefficient to load an entire function directly into the L1 instruction cache, since an equal size of instructions that are currently present in the L1 instruction cache will need to be evicted. At the same time, the entire function is present in the L2 cache, wherein eviction of cache lines creates less of a performance problem. As discussed above, it is desired to increase the ratio of cache hits vs. misses. Also, recall that each cache miss results in a latency penalty. A complete cache miss (meaning the instruction is not present in either the L1 instruction cache or the L2 cache) results in a significantly larger penalty than an L1 miss, since a cache line must be retrieved from system memory, which is considerably slower than the memory used for an L2 cache. Additionally, by using a background task to load the function instructions into the L2 cache, these operations are transparent to both the processor and the L1 instruction cache.

The scheme depicted in FIG. 3b is merely illustrative of one embodiment of this approach. Under other embodiments, a larger portion of instructions may be immediately loaded into the L1 instruction cache, such as 2+cache lines. In one embodiment, the number of cache lines to initially load may be defined in an augmented function memory map that includes an additional column containing such information (not shown).

Another aspect of the function caching scheme is the ability to add further granularity to function caching operations. For example, since it is well recognized that only a small portion of functions for a given application represent the bulk of processing operations for that application under normal usage, it may be desired to cache selected high-use functions, while not caching other functions. It may also be desired to immediately cache entire functions into an L1 cache, while caching other functions into the L2 cache or not at all.

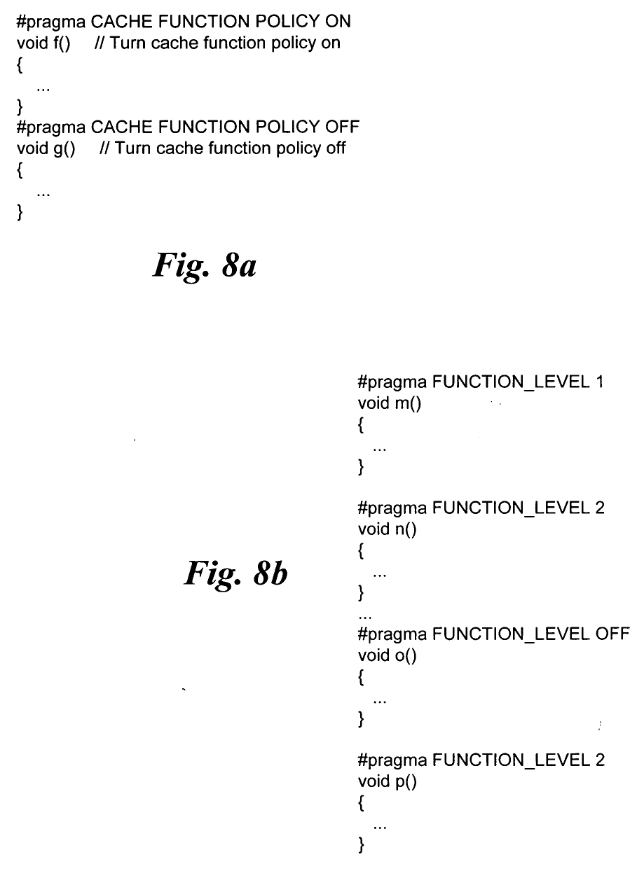

Under one embodiment, granular control of function caching behavior is enabled by providing corresponding markers in the source-level code. For example, FIG. 8a depicts one exemplary scheme that employs pragma statements employed in the C and C++ languages. Pragma statements are typically employed to instruction the compiler to perform an operation specified by the statement. Under the example illustrated in FIG. 8a, respective pragma statements are employed to turn a cache function policy on and off. When the cache function policy is turned on, corresponding functions in the source-level code are marked at the assembly level such that corresponding entries are made to the function address map. When the cache function policy is turned off, there are no markers generated at the assembly level for the source-level functions.

Under the scheme depicted in FIG. 8b, another layer of granularity is provided. In this instance, pragma statement are used to mark whether a given function (or number of functions in a marked source-level code section) is to be immediately loaded into an L1 cache (as defined by a #pragma FUNCTION_LEVEL 1 statement), background loaded into an L2 cache (as defined by a #pragma FUNCTION_LEVEL 2 statement), or not loaded into either the L1 or L2 cache (as defined by a #pragma FUNCTION_LEVEL OFF statement).

In connection with loading function instructions into caches, there needs to be appropriate cache eviction policies. Under conventional caching schemes, only a single cache line is evicted at a time. As discussed above, conventional cache eviction policies employ include random, LRU and pseudo LRU algorithms. In contrast, multiple cache lines will need to be evicted to load the instructions for most functions. Thus, the granularity of the eviction policy must change from single line to multiple lines.

In one embodiment, an LRU function eviction policy is employed. Under this scheme, the applicable cache level cache eviction policy logic maintains indicia identifying the order of cached function access. Thus, when a set of cache lines need to be evicted, cache lines for a least recently used function are selected. If necessary, cache lines corresponding to multiple LRU functions may need to be evicted for functions that require more cache lines that the functions they are evicting.

In other embodiments, random and pseudo LRU algorithms may be employed, both at the function level and at a cache line set level. For instance, a random cache line set replacement algorithm may select a random number of sequential cache lines to evict, or may select a set of cache lines corresponding to a random function. Similar schemes may be employed using an pseudo LRU algorithm at the function level or cache line set level using logic similar to that employed by pseudo LRU algorithms to evict individual cache lines.

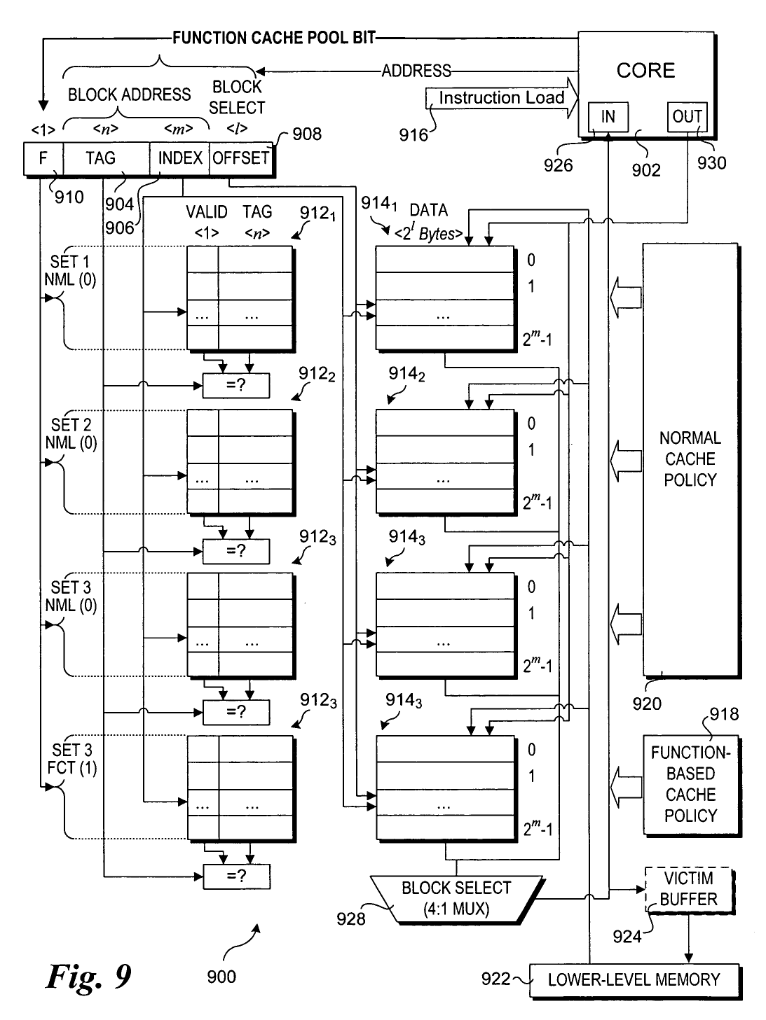

In yet another scheme, a portion of a cache is dedicated to storing cache lines related to functions, while other portions of the cache are employed for caching individual cache lines in the conventional manner. For example, one embodiment of such a scheme implemented on a 4-way set associative cache is shown in FIG. 9.

In general, cache architecture 900 of FIG. 9 is representative of an n-way set associative cache, with a 4-way implementation detailed herein for clarity. The main components of the architecture include a processor 902, various cache control elements (specific details of which are described below) collectively referred to as a cache controller, and the actual cache storage space itself, which is comprised of memory used to store tag arrays and cache lines, also commonly referred to a blocks.

The general operation of cache architecture 900 is similar to that employed by a conventional 4-way set associative cache. In response to a memory access request (made via execution of a corresponding instruction or instruction sequence), an address referenced by the request is forwarded to the cache controller. The fields of the address are partitioned into a TAG 904, an INDEX 906, and a block OFFSET 908. The combination of TAG 904 and INDEX 906 is commonly referred to as the block (or cache line) address. Block OFFSET 908 is also commonly referred to as the byte select or word select field. The purpose of a byte/word select or block offset is to select a requested word (typically) or byte from among multiple words or bytes in a cache line. For example, typical cache lines sizes range from 8-128 bytes. Since a cache line is the smallest unit that may be accessed in a cache, it is necessary to provide information to enable further parsing of the cache line to return the requested data. The location of the desired word or byte is offset from the base of the cache line, hence the name block “offset.”

Typically, l least significant bits are used for the block offset, with the width of a cache line or block being 2^{l} bytes wide. The next set of m bits comprises INDEX 906. The index comprises the portion of the address bits, adjacent to the offset, that specify the cache set to be accessed. It is m bits wide in the illustrated embodiment, and thus each array holds 2^{m} entries. It is used to look up a tag in each of the tag arrays, and, along with the offset, used to look up the data in each of the cache line arrays. The bits for TAG 904 comprise the most significant n bits of the address. It is used to lookup a corresponding TAG in each TAG array.

All of the aforementioned cache elements are conventional elements. In addition to these elements, cache architecture 900 employs a function cache pool bit 910. The function cache pool bit is used to select a set in which the cache line is to be searched and/or evicted/replaced (if necessary). Under cache architecture 900, memory array elements are partitioned into four groups. Each group includes a TAG array 912ⱼ and a cache line array 914ⱼ, wherein j identifies the group (e.g., group 1 includes a TAG array 912ₗ and a cache line array 914ₗ).

In response to a memory access request, operation of cache architecture 900 proceeds as follows. In the illustrated embodiment, processor 902 receives an instruction load request 916 referencing a memory address at which the instruction is stored. In the illustrated embodiment, the groups 1, 2, 3 and 4 are partitioned such that groups 1-3 are employed for the normal (i.e., conventional) cache operations, while group 4 is employed for the function-based cache operations corresponding to aspects of the embodiments discussed above. Other partitioning schemes may also be implemented in a similar manner, such as splitting the groups evenly, or using a single pool for the normal cache pool while using the other three pools for the function-based cache pool.

In response to determining the instruction belongs to a cacheable function (defined by the function memory map), a function cache pool bit having a high logic level (1) is appended as a prefix to the address and provided to the cache controller logic. In one embodiment, the high priority bit is stored in one 1-bit register, while the address is stored in another w-bit register, wherein w is the width of the address. In another embodiment, the combination of the priority bit and address are stored in a register that is w+1 wide.

In response to the cache miss for a function instruction, the cache controller selects a cache line or set of cache lines (depending on the function caching policy applicable for the function) from group 4 to be replaced. In the illustrated embodiment, separate cache policies are implemented for each of the normal- and function-based pools, depicted as normal cache policy 918, a function-based cache policy 920.

Another operation performed in conjunction with selection of the cache line(s) to evict is the retrieval of the requested data from lower-level memory 922. This lower-level memory is representative of a next lower level in the memory hierarchy of FIG. 1, as relative to the current cache level. For example, cache architecture 900 may correspond to an L1 cache, while lower-level memory 922 represents an L2 cache, cache architecture 900 corresponds to an L2 cache, and lower-level memory 922 represents system memory, etc. Under an optional implementation of cache architecture 900, an exclusive cache architecture employing a victim buffer 924 is employed.

Upon return of the requested instruction(s) to the cache controller, the instructions are copied into the evicted cache line(s), and the corresponding TAG and valid bit is updated in the appropriate TAG array (TAG array 912₄ in the present example). A word containing the current instruction (corresponding to the original instruction retrieval request) in an appropriate cache line is then read from the cache into an input register 926 for processor 902, with the assist of a 4:1 block selection multiplexer 928. An output register 930 is provided for performing cache update operations in connection with data cache write-back operations corresponding to conventional cache operations supported by cache architecture 900.

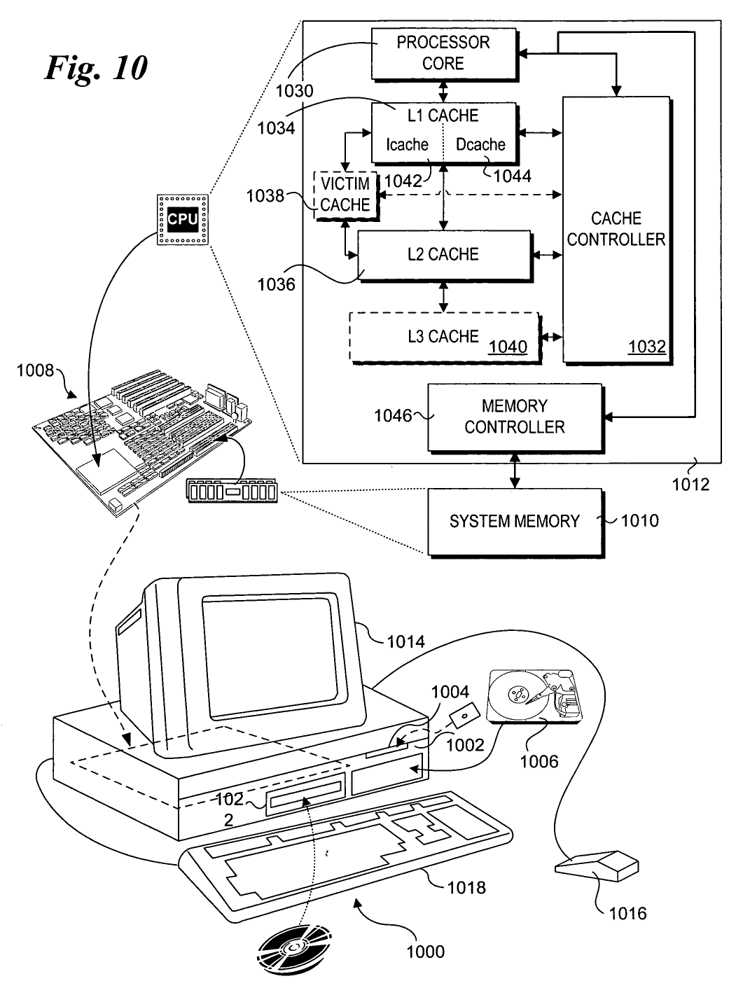

With reference to FIG. 10, a generally conventional computer 1000 is illustrated, which is representative of various computer systems that may employ processors having the cache architectures described herein, such as desktop computers, workstations, and laptop computers. Computer 1000 is also intended to encompass various server architectures, as well as computers having multiple processors.

Computer 1000 includes a chassis 1002 in which are mounted a floppy disk drive 1004 (optional), a hard disk drive 1006, and a motherboard 1008 populated with appropriate integrated circuits, including system memory 1010 and one or more processors (CPUs) 1012, as are generally well-known to those of ordinary skill in the art. System memory 1010 may comprise various types of memory, such as SDRAM (Synchronous DRAM) double-data-rate (DDR) DRAM, Rambus DRAM, etc. A monitor 1014 is included for displaying graphics and text generated by software programs and program modules that are run by the computer. A mouse 1016 (or other pointing device) may be connected to a serial port (or to a bus port or USB port) on the rear of chassis 1002, and signals from mouse 1016 are conveyed to the motherboard to control a cursor on the display and to select text, menu options, and graphic components displayed on monitor 1014 by software programs and modules executing on the computer. In addition, a keyboard 1018 is coupled to the motherboard for user entry of text and commands that affect the running of software programs executing on the computer.

Computer 1000 may also optionally include a compact disk-read only memory (CD-ROM) drive 1022 into which a CD-ROM disk may be inserted so that executable files and data on the disk can be read for transfer into the memory and/or into storage on hard drive 1006 of computer 1000. Other mass memory storage devices such as an optical recorded medium or DVD drive may be included.

Architectural details of processor 1012 are shown in the upper portion of FIG. 10. The processor architecture includes a processor core 1030 coupled to a cache controller 1032 and an L1 cache 1034. The L1 cache 1034 is also coupled to an L2 cache 1036. In one embodiment, an optional victim cache 1038 is coupled between the L1 and L2 caches. In one embodiment, the processor architecture further includes an optional L3 cache 1040 coupled to L2 cache 1036. Each of the L1, L2, L3 (if present), and victim (if present) caches are controlled by cache controller 1032. In the illustrated embodiment, L1 cache employs a Harvard architecture including an instruction cache (Icache) 1042 and a data cache (Dcache) 1044. Processor 1012 further includes a memory controller 1046 to control access to system memory 1010. In general, cache controller 1032 is representative of a cache controller that implements cache control elements of the cache architectures and schemes described herein.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the drawings. Rather, the scope of the invention is to be determined entirely by the following claims, which are to be construed in accordance with established doctrines of claim interpretation.

What is claimed is:

1. A method, comprising:
caching instructions corresponding to one of an application or application module based on programmatic characteristics of the application or application module.

2. The method of claim 1, wherein the programmatic characteristics correspond to functions defined for the application or application module, and a function-based caching scheme is employed.

3. The method of claim 2, further comprising:
determining a current instruction located at a memory address identified by an instruction pointer is not present in a cache;
determining if the current instruction corresponds to the first instruction of a function; and in response thereto,
loading instructions for the function into the cache.

4. The method of claim 3, further comprising:
immediately loading at least one cache line including a first portion of function instructions into the cache; and
asynchronously loading a second portion of the function instructions into the cache using at least one additional cache line.

5. The method of claim 3, further comprising:
generating a function memory map identifying the memory location of a first instruction for each of a plurality of functions to be cached; and
performing a lookup of the function memory map to determine if a current instruction corresponds to the first instruction of a function to be cached.

6. The method of claim 2, further comprising:
enabling a programmer to specify how caching of the instructions for selected functions of the application or application module is to be performed.

7. The method of claim 6, further comprising:
enabling a programmer to specify how caching of the instructions for selected functions of the application or application is to be performed under a multi-level caching scheme.

8. The method of claim 2, further comprising:
determining a current instruction located at a memory address identified by an instruction pointer is not present in a first level cache;
determining if the current instruction corresponds to the first instruction of a function; and in response thereto,
loading a first portion of instructions for the function into the first level cache; and
loading at least a second portion of the instructions for the function into a second level cache.

9. The method of claim 8, wherein said at least a second portion of the instruction for the function are loaded into the second level cache using an asynchronous background operation.

10. The method of claim 2, further comprising:
partitioning memory resources for a cache into a first pool employed for conventional cache operations and a second pool employed for function-based cache operations; and, in response to a request to load an instruction that is not part of a function to be cached,
employing conventional cache line eviction and write operations to load the instruction into a memory resource corresponding to the first pool; otherwise, in response to a request to load an instruction that is part of a function to be cached,
employing a function-based cache policy to load instructions corresponding to the function into memory resources corresponding to the second pool.

11. The method of claim 2, further comprising:
employing a function-based cache eviction policy to select cache lines to evict from the cache, wherein the cache lines selected for eviction contain instructions corresponding to at least one function that was previously cached.

12. A processor, comprising:
a processor core;
an instruction pointer;
a cache controller, coupled to the processor core;
a first cache, controlled by the cache controller and operatively coupled to receive data from and to provide data to the processor core, the cache including at least one TAG array and at least one cache line array,
wherein the cache controller is programmed to cache instructions corresponding to one of an application or application module in the first cache based on programmatic characteristics of the application or application module.

13. The processor of claim 12, wherein the programmatic characteristics correspond to functions defined for the application or application module, and the cache controller is programmed to facilitate a function-based caching scheme.

14. The processor of claim 13, wherein the cache controller is programmed to:
determine a current instruction located at a memory address identified by an instruction pointer for the processor is not present in the first cache;
determine if the current instruction corresponds to the first instruction of a function; and in response thereto,
load instructions for the function into the first cache.

15. The processor of claim 13, wherein the cache controller is configured to control operation of a second cache, the first cache comprising a first level cache and the second cache comprising a second level cache, and the cache controller is programmed to:
determine a current instruction located at a memory address identified by an instruction pointer is not present in the first cache;
determine if the current instruction corresponds to the first instruction of a function; and in response thereto,
load a first portion of instructions for the function into the first cache; and
load at least a second portion of the instructions for the function into the second cache.

16. The processor of claim 13, wherein the first cache comprises a memory resource that is logically partitioned into first and second pools, and the cache controller is programmed to:
determine if a current instruction pointed to by the instruction pointer corresponds to a first instruction of a function to be cached; and if so,
employ a function-based cache policy to load instructions corresponding to the function into a portion of the memory resource corresponding to the first pool; otherwise,
employ a conventional cache line eviction and load policy to replace a selected cache line with a new cache line including the instruction in a portion of the memory resource corresponding to the second pool.

17. The processor of claim 12, wherein the cache controller is programmed to:
employ a function-based cache eviction policy to select cache lines to evict from the cache, wherein the cache lines selected for eviction contain instructions corresponding to a function that was previously cached in the first cache.

18. The processor of claim 12, further comprising a content-addressable memory (CAM) and the processor is programmed, in response to execution of corresponding instructions, to store data pertaining to a function memory map in the CAM, the data including a respective entry for each of a plurality of functions to be cached for the application or application module, each entry identifying a memory address at which a first address for a corresponding function is located and an address range spanned by the function upon being loaded into memory.

19. A computer system comprising:
memory, to store program instructions and data, comprising SDRAM (Synchronous Dynamic Random Access Memory);
a memory controller, to control access to the memory; and
a processor, coupled to the memory controller, including,
a processor core;
in instruction pointer;
a cache controller, coupled to the processor core;
a first-level (L1) cache, controlled by the cache controller and operatively coupled to receive data from and to provide data and instructions to the processor core; and
a second-level (L2) cache, controlled by the cache controller and operatively coupled to receive data and instructions from and to provide data and instructions to the L1 cache,
wherein the cache controller is programmed to cache instructions corresponding to one of an application or application module using a function-based caching scheme under which sets of instructions corresponding to functions defined in the application or application module are cached in at least one of the L1 and L2 caches.

20. The computer system of claim 19, wherein the cache controller is programmed to load instructions corresponding to a function into one of the L1 and L2 caches in response to a request to access a first instruction for the function.

21. The computer system of claim 20, wherein the cache controller is programmed to:
load a first portion of instructions for the function into the L1 cache; and
load at least a second portion of the instructions for the function into the L2 cache.

22. The computer system of claim 19, wherein the L2 cache comprises an n-way set associative cache having cache lines partitioned into first and second pools, and the cache controller is programmed to:
determine if a current instruction pointed to by the instruction pointer corresponds to a first instruction of a function to be cached; and if so,
employ a function-based cache policy to load instructions corresponding to the function using multiple cache lines corresponding to the first pool; otherwise,
employ a conventional cache line eviction and load policy to replace a selected cache line in the second pool with a new cache line including the instruction.
